(19) United States
(12) Patent Application Publication
(10) Pub. No.: US 2026/0010846 A1
(43) Pub. Date: Jan. 8, 2026

(54) HEALTHCARE SUPPLY CHAIN FORECASTING

(71) Applicant: Tiny Maple Ventures Inc., Toronto (CA)

(72) Inventor: Ryan Doherty, Toronto (CA)

(21) Appl. No.: 19/261,151

(22) Filed: Jul. 7, 2025

Related U.S. Application Data
(60) Provisional application No. 63/667,997, filed on Jul. 5, 2024.

(51) Int. Cl. G06Q 10/0631

(52) U.S. Cl. CPC G06Q 10/06315

(57) ABSTRACT

Described herein are systems and methods for generating a data subset prediction and providing a healthcare related service based on said data subset prediction. In some examples, the method includes: (a) retrieving data from a plurality of data sources; (b) sorting the retrieved data into data groups; (c) providing the data group with a data group identifier; (d) providing each of the retrieved data subsets with a retrieved data subset trust score; (e) comparing the data group identifier with stored data group identifiers of stored data groups; (f) adding the retrieved data subset and its associated retrieved data subset trust score to one of the stored data groups; (g) identifying a data subset prediction; (h) identifying at least one of the stored data groups required to generate the data subset prediction; (i) generating the data subset prediction; and (j) modifying a healthcare service based on the data subset prediction.

### CROSS REFERENCE TO RELATED APPLICATIONS

This application claims the benefit of the filing date of U.S. Provisional Patent Application Ser. No. 63/667,997, filed Jul. 5, 2024, the specification of which is incorporated herein by reference.

### FIELD

The specification relates generally to data forecasting, and specifically to systems and methods for generating data predictions pertaining to the healthcare field. The results of the data predictions may be used by entities in the healthcare field to eliminate inefficiencies which have been found in known methods of supply chain management.

### BACKGROUND

Supply chain management is often completed in a routine manner across many fields, including, for example, in healthcare and healthcare-related industries. However, healthcare systems are dynamic and always changing, and imbalances in supply and demand may lead to access issues, delays, wait-times, and wasted or inefficient use of limited resources. Individuals and entities may have difficulty performing healthcare resource planning using traditional methods because they unknowingly rely on information that is incomplete and/or information which turns out to be incorrect. Incorrect or otherwise incomplete information may negatively influence service availability, appointment availability, workforce staff schedule planning, and inventory planning. For example, Just-in-Time inventory management may be used to reduce storage costs by receiving medical supplies only as they are needed based on minimum stock thresholds or prior usage, however, this may lead to stockouts during surges and when demand differs from historical norms. Use of Periodic Automatic Replenishment systems where items have a pre-set reorder quantity based on historical usage and/or historical consumption rates may also lead to both stockout and delays during surge and times of unexpected increased demand in addition to waste from over-ordering during periods of low-demand. Further, some healthcare organizations rely on manual ordering based on staff intuition, which is influenced by cognitive bias and inconsistencies, challenges while scaling and the process relies on availability of experienced staff and training of new staff.

Within the field of healthcare, inefficiencies in supply chain management can stem from lack of data-driven processes and/or use of processes that rely on poor quality data and inaccurate data predictions. Issues including and similar to those mentioned previously can have a significant negative impact on budgets, planning, coordination of services, access to care, and quality of life for both patients and healthcare providers.

### SUMMARY OF THE INVENTION

This summary is intended to introduce the reader to the more detailed description that follows and not to limit or define any claimed or as yet unclaimed invention. One or more inventions may reside in any combination or sub-combination of the elements or method steps disclosed in any part of this document including its claims and figures.

According to one aspect of this disclosure, there is provided a method for generating a data subset prediction and providing a healthcare service based on said data subset prediction. The method may include retrieving data from a plurality of data sources, wherein one or more of the plurality of data sources may comprise at least one of structured and unstructured data. The method may include sorting the retrieved data into data groups of retrieved data subsets. For each of the data groups, the method may include providing the data group with a data group identifier. The method may include providing each of the retrieved data subsets within each of the data groups with a retrieved data subset trust score. The retrieved data subset trust score may be based on at least one of (a) an identity of the data source; (b) an origination date of the retrieved data; (c) subject matter of the retrieved data; and (d) consistency of the retrieved data subset with other retrieved data. For each of the data groups, the method may include comparing the data group identifier with stored data group identifiers of stored data groups which may be stored on at least one memory device. The stored data groups may each comprise at least one previously retrieved data subset, wherein each of the at least one previously retrieved data subsets may have a previously retrieved data subset trust score. For each of the retrieved data subsets of each of the data groups, the method may include adding the retrieved data subset and its associated retrieved data subset trust score to one of the stored data groups of the stored data groups if the data group identifier of the data group of the retrieved data subset matches a stored data group identifier of the stored data group. The retrieved data subset and its associated retrieved data subset trust score being added to the stored data group having the stored data group identifier that matches the data group identifier of the data group of the retrieved data subset. The method may include identifying a data subset prediction to generate. The method may include identifying at least one of the stored data groups required to generate the data subset prediction. The method may include generating the data subset prediction based on the added retrieved data subset and its associated retrieved data subset trust score of the stored data group required to generate the data subset prediction and the previously retrieved data subsets and its associated previously retrieved data subset trust scores of the stored data group required to generate the data subset prediction. The method may include modifying a healthcare related service based on the data subset prediction.

In some embodiments, the method may comprise providing the identified data subset prediction to generate with a data subset prediction identifier. Identifying the at least one of the stored data subsets required to generate the data subset prediction may comprise matching the data subset prediction identifier with a stored data subset identifier of the stored data subsets.

In some embodiments, identifying the at least one of the stored data subsets required to generate the at least one data subset prediction may comprise (a) identifying at least one data type subset within the identified data subset prediction to generate required to generate the data subset prediction; (b) providing each of the at least one data type subsets with a data type subset identifier; and (c) matching each of the at least one data type subset identifiers with a stored data subset identifier of the stored data subsets.

In some embodiments, retrieving data from a plurality of data sources may comprise retrieving data from at least one forecasting entity. The data retrieved from the forecasting entity may include at least one retrieved data subset. At least one of the at least one retrieved data subset may be a first retrieved data subset belonging to a data group having a first data group identifier.

In some embodiments, identifying the at least one of the stored groups required to generate the at least one data subset prediction may comprise matching the data subset prediction identifier with a stored data subset identifier of the stored data subsets having the first data group identifier.

In some embodiments, the method may comprise removing each of the at least one retrieved data subset retrieved from the forecasting entity from the stored data subset of the stored data subsets after generating the data subset prediction.

In some embodiments, the method may comprise updating the retrieved data subset trust score after adding the retrieved data subset of that retrieved data subset trust score to the one of the stored data groups of the stored data groups based on consistency of the retrieved data subset with the previously retrieved data subsets in that stored data group of the stored data groups.

In some embodiments, the method may comprise updating the previously retrieved data subset trust scores after generating the data subset prediction based on a correctness of the generated data subset prediction.

In some embodiments, retrieving data from a plurality of data sources may comprise retrieving data from at least one operating entity.

In some embodiments, the data subset prediction may comprise a likeliness score.

In some embodiments, for each retrieved data subset of each of the data groups, the method may comprise generating a new stored data group with the stored data groups which are stored on the at least one memory device. The new stored data group may include that retrieved data subset and its associated retrieved data subset trust score, if the data group identifier of the data group of that retrieved data subset does not match a stored data group identifier of the stored data groups.

In some embodiments, generating the data subset prediction may comprise use of artificial intelligence and/or data analytics based on, at least in part, one or more of the retrieved data subset trust score, the previously retrieved data subset trust score, and historical data.

In some embodiments, providing each of the retrieved data subsets within each of the data groups with the retrieved data subset trust score may comprise (a) comparing that retrieved data subset with a stored data subset, wherein the data group identifier of the data group of that retrieved data subset matches the stored data group identifier of the stored data group of the stored data subset being compared to; and (b) determining the retrieved data subset trust score based at least in part on the similarity between that retrieved data subset and the stored data subset.

In some embodiments, the data subset prediction may be demand for a healthcare service within a geographical region.

In some embodiments, the data subset prediction may be an operating status of a healthcare operating entity.

In some embodiments, the data subset prediction may be a repercussion indication.

In some embodiments, the method may comprise (a) identifying a second data subset prediction to generate; (b) identifying at least one of the stored data groups required to generate the second data subset prediction; and (c) generating the second data subset prediction based on the added retrieved data subset and its associated retrieved data subset trust score of the stored data group required to generate the second data subset prediction and the previously retrieved data subsets and its associated previously retrieved data subset trust scores of the stored data group required to generate the second data subset prediction.

In accordance with another aspect, there is provided a system for generating a data subset prediction. The system for generating a data subset prediction may comprise a data handling engine in communication with a plurality of data sources comprising (a) at least one memory device configured to store computer-executable instructions and the data subset prediction; and (b) a processing device coupled to the memory device. The computer executable instructions when executed by the processing device may cause the processing device to (a) retrieve data from a plurality of data sources, wherein one or more of the plurality of data sources may comprise at least one of structured and unstructured data; (b) sort the retrieved data into data groups of retrieved data subsets; (c) for each of the data groups, provide the data group with a data group identifier; (d) provide each of the retrieved data subsets within each of the data groups with a retrieved data subset trust score, wherein the retrieved data subset trust score is based on at least one of (i) an identity of the data source; (ii) an origination date of the retrieved data; (iii) subject matter of the retrieved data; and (iv) consistency of the retrieved data subset with other retrieved data; (e) for each of the data groups, compare the data group identifier with stored data group identifiers of stored data groups which are stored on at least one memory device, wherein the stored data groups each comprise at least one previously retrieved data subset, wherein each of the at least one previously retrieved data subsets has a previously retrieved data subset trust score; (f) for each of the retrieved data subsets of each of the data groups, add the retrieved data subset and its associated retrieved data subset trust score to one of the stored data groups of the stored data groups if the data group identifier of the data group of the retrieved data subset matches a stored data group identifier of the stored data group, the retrieved data subset and its associated retrieved data subset trust score being added to the stored data group having the stored data group identifier that matches the data group identifier of the data group of the retrieved data subset; (g) identify a data subset prediction to generate; (h) identify at least one of the stored data groups required to generate the data subset prediction; and (i) generate the data subset prediction based on the added retrieved data subset and its associated retrieved data subset trust score of the stored data group required to generate the data subset prediction and the previously retrieved data subsets and its associated previously retrieved data subset trust scores of the stored data group required to generate the data subset prediction.

In some embodiments, the retrieved data may be encrypted and the computer-executable instructions when executed by the processing device may further cause the processing device to decrypt the retrieved data.

In some embodiments, the system for generating a data subset prediction may comprise an application interface for the data handling engine.

In accordance with another aspect, there is provided a non-transitory computer readable medium for generating a data subset prediction comprising computer-executable instructions. The computer-executable instructions may be for (a) retrieving data from a plurality of data sources, wherein one or more of the plurality of data sources comprises at least one of structured and unstructured data; (b) sorting the retrieved data into data groups of retrieved data subsets; (c) for each of the data groups, providing the data group with a data group identifier; (d) providing each of the retrieved data subsets within each of the data groups with a retrieved data subset trust score, wherein the retrieved data subset trust score is based on at least one of: (i) an identity of the data source; (ii) an origination date of the retrieved data; (iii) subject matter of the retrieved data; and (iv) consistency of the retrieved data subset with other retrieved data; (e) for each of the data groups, comparing the data group identifier with stored data group identifiers of stored data groups which are stored on at least one memory device, wherein the stored data groups each comprise at least one previously retrieved data subset, wherein each of the at least one previously retrieved data subsets has a previously retrieved data subset trust score; (f) for each of the retrieved data subsets of each of the data groups, adding the retrieved data subset and its associated retrieved data subset trust score to one of the stored data groups of the stored data groups if the data group identifier of the data group of the retrieved data subset matches a stored data group identifier of the stored data group, the retrieved data subset and its associated retrieved data subset trust score being added to the stored data group having the stored data group identifier that matches the data group identifier of the data group of the retrieved data subset; (g) identifying a data subset prediction to generate; (h) identifying at least one of the stored data groups required to generate the data subset prediction; and (i) generating the data subset prediction based on the added retrieved data subset and its associated retrieved data subset trust score of the stored data group required to generate the data subset prediction and the previously retrieved data subsets and its associated previously retrieved data subset trust scores of the stored data group required to generate the data subset prediction.

### BRIEF DESCRIPTIONS OF THE DRAWINGS

For a better understanding of the various aspects of the application described herein and to show more clearly how they may be carried into effect, reference will now be made, by way of example only, to the accompanying drawings in which:

FIG. 1 depicts a flowchart illustrating a method of generating a data subset prediction, according to non-limiting embodiments; and

FIG. 2 depicts a schematic of a system for generating a data subset prediction, according to non-limiting embodiments.

### DETAILED DESCRIPTION

Herein described are systems and methods for generating data subset predictions. A data subset prediction may be any one of a forecasted demand, a forecasted availability, and a forecasted impact which is based on a dataset of retrieved data from a plurality of data sources. A data subset prediction is a “subset prediction”, because the dataset used to generate the data subset prediction may include data which is not required to generate, and is not taken into consideration when generating, the data subset prediction.

It will be appreciated that for simplicity and clarity of illustration, where considered appropriate, reference numerals may be repeated among the figures to indicate corresponding or analogous elements. In addition, numerous specific details are set forth in order to provide a thorough understanding of the exemplary aspects of the present application described herein. However, it will be understood by those of ordinary skill in the art that the exemplary aspects described herein may be practiced without these specific details. In other instances, well-known methods, procedures and components have not been described in detail so as not to obscure the exemplary aspects described herein. Also, the description is not to be considered as limiting the scope of the exemplary aspects described herein. Any systems, method steps, components, parts of components, and the like described herein in the singular are to be interpreted as also including a description of such systems, method steps, components, parts of components, and the like in the plural, and vice versa.

When generating data subset predictions which relate to healthcare supply, there may be an increased desire to provide accurate forecasts of demand, availability, and/or impact because of the severity of the repercussions that can stem from an inaccurate prediction, including inefficient allocation of both monetary and non-monetary resources (e.g., clinician staffing), reduced patient safety, and stockouts. As alluded to above, there are many challenges when generating data subset predictions, particularly when the datasets being relied upon to generate the predictions are based on information or data from sources outside of one's control.

To generate an accurate data subset prediction, it has been determined that a trustworthy database and supply chain forecasting (i.e., trustworthy data analytic models) are required. However, data pertaining to the healthcare field is often inaccurate or not available. Healthcare supply data is often inaccurate or not available because information is often changing with many dependencies, and operating entities (i.e., entities in the healthcare field that provide healthcare or healthcare related services) are often understaffed and/or under resourced with constrained planning due to incomplete and inaccurate information. Further, the supply of healthcare related services often relies on multiple operating entities, and therefore the data required to generate a prediction regarding that healthcare related service may require data to be provided from each of those multiple operating entities. Accordingly, datasets which relate to healthcare related services are often incomplete and/or are generated based on information from sources outside of one's control and may be based on information which is difficult to verify and/or contradictory. Healthcare supply data or datasets which relate to healthcare related services that are inaccurate or not available are not always recognized as such by existing methods of supply chain forecasting. By failing to account for these factors, entities such as downstream systems and decision-makers may be required to individually evaluate the accuracy of single data sources, which may require excess human and/or computer resources.

To generate accurate data subset predictions, the described methods and systems may account for the factors described in the previous paragraph by operating on an understanding that no single data source is 100% reliable and that information is always changing. To operate in this way, the described methods and systems draw from a plurality of data sources and context is added to support forecasting. Data is aggregated across a plurality of data sources, both structured and unstructured, without trusting any individual source such that the dataset built using data from those data sources becomes trustworthy on aggregate. To do so, a trust score is assigned to retrieved data which is an estimated accuracy of the retrieved data. Further, the described methods and systems may match and compare across various datasets from different data sources on a frequent basis (e.g., continuously, on a rolling basis and/or in real-time).

There are many factors that can be considered when providing retrieved data with a trust score. For example, any one of an identity of the data source, method of data retrieval, an origination date of the retrieved data, subject matter of the retrieved data; and consistency of the retrieved data with other retrieved data may be considered when providing received data with a trust score. It will be appreciated that multiple factors may be jointly considered when providing retrieved data with a trust score. In addition to those listed previously, other factors may be used when providing retrieved data with a trust score. For example, factors that relate to business relationships may be used. That is, for example, data retrieved from a first entity which relates to a second entity may be considered to be accurate if it is known that the first and second entities are partner organizations (if the first and second entities were not partner organizations, it may be less likely that the first entity has accurate information about the second entity). Another factor that may be considered when providing received data with a trust score is the IT infrastructure of the data source and the method by which the data is retrieved (e.g., data about an entity received by phone from that entity may be considered relatively trustworthy and data received through direct real-time integration with their staffing scheduling software may be considered even more trustworthy).

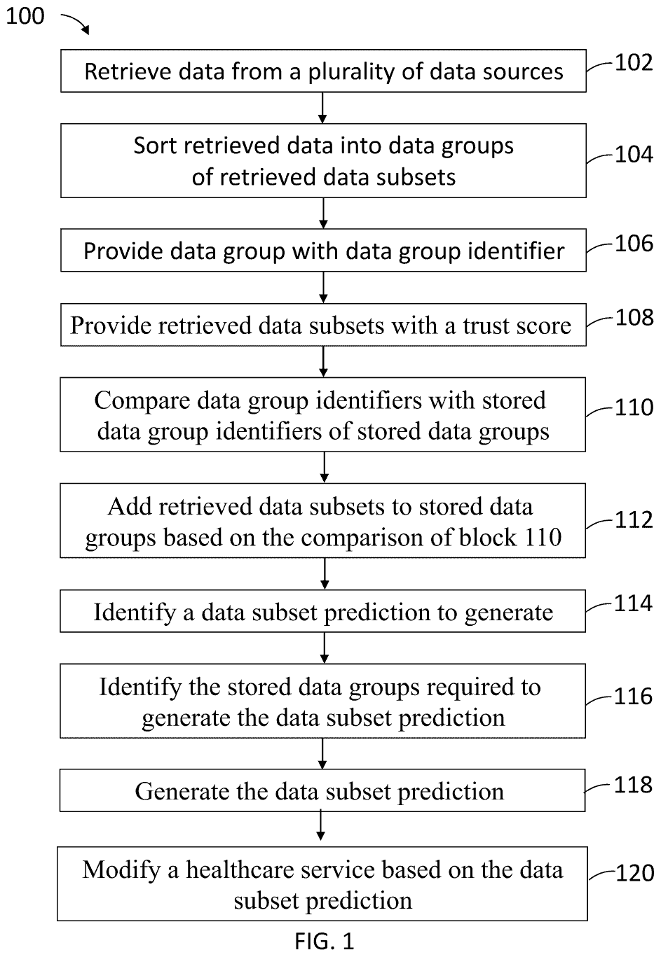

Referring now to FIG. 1, shown therein is a flowchart of a method 100 for generating a data subset prediction, according to non-limiting aspects of the application. It is to be emphasized that method 100 need not be performed in the exact sequence as shown, unless otherwise indicated; and likewise various blocks may be performed in parallel rather than in sequence; hence the elements of method 100 may be referred to herein as “blocks” rather than “steps”. Further, it is to be understood that while the description herein relates generally to the healthcare industry, the systems and methods may be applied to and used in other industries as well.

As shown in FIG. 1, method 100 may start at block 102, in which data is retrieved from a plurality of data sources. The data sources may be any entity capable of providing data actively and/or passively. In some examples, the data sources are associated with healthcare operating entities (e.g., a pharmacy, hospital, medical clinic, government healthcare agency, etc.) and/or an individual (e.g., a patient/client, physician, other healthcare professionals, etc.).

The data sources may comprise structured and/or unstructured data. Further, the data sources may comprise a variety of data, including data that may be incongruous or otherwise conflicting with other data. For example, a first data source and a second data source may both comprise information about the same client, but some of the information stored at the first data source may not match that held at the second data source (e.g., the date of birth of a client may be listed as Jan. 15, 1985 at the first data source, but may be listed as Jan. 21, 1989 at the second data source). As another example, the first data source and the second data source may both comprise information about a healthcare professional, but some of the information stored at the first data source may not match that held at the second data source (e.g., a primary care physician was confirmed to be accepting new clients at the first data source, while the second data source states that the primary care physician is not actively accepting new clients).

Data sources may comprise any suitable data storage type or technical type. For example, according to some embodiments, the data sources comprise one or more of a database, a data feed, and a data structure. Accordingly, data may be retrieved in real-time via system integration with content management systems (CMS), electronic medical record software (EMR), electronic health records (EHR), customer relationship management (CRM), enterprise resource planning software (ERP) and inventory management software, scheduling calendars, internal & external facing databases, and repositories. In some examples, data from data sources may be retrieved through physical measurement and surveying of patients and systems and corresponding input of such data by an operator. In some examples, for comprehensive data collection, information may also be retrieved by way of phone, fax, email, surveys, census, and/or public postings.

As noted above, each of the plurality of data sources may comprise structured and/or unstructured data. Structured data for healthcare facilities can include, for example, healthcare organization name, telecommunication information, mailing address, physical location, hours of operations, affiliations, service availability, and many other facility, operational and technical attributes. Structured data for healthcare professionals can include, for example, name, date of birth, academic credentials, affiliations with professional associations, academic and professional experience, and many other personal and professional attributes. Unstructured data about healthcare facilities can include, for example, descriptive information about the healthcare facility and public discourse related to the organization and services it offers, along with many other informational attributes.

According to some embodiments, data may be retrieved from each one of the data sources at a different frequency. For example, according to some embodiments, data may be retrieved from a first data source on a real-time basis, whereas data may be retrieved from a second data source daily, weekly, monthly, or annually. Accordingly, it is to be understood that at block 102, retrieving data from a plurality of data sources may or may not take place over an extended period of time. Further, the data may be retrieved from one data source in a first way and retrieved from a second data source in an alternative way (e.g., by way of electronic data transfer vs. physical collection).

Still with reference to FIG. 1, at block 104, the retrieved data is sorted into data groups of retrieved data subsets. A data group includes data (i.e., retrieved data subsets) that relates to a particular type of data. For example, a data group may be hours of operation of a first operating entity. A data group may be hours of operation of the first operating entity on a particular statutory holiday. As another example, a data group may be an indication of how many flu vaccines a second operating entity has in stock. As yet another example, a data group may be the number of clients a third operating entity saw in the first quarter of the previous year.

Each data group may contain multiple retrieved data subsets, because, for example, multiple data sources of the plurality of data sources may provide data that relates to the same data group. For example, data may be retrieved from both a first and second data source which pertains to the operating status of a first operating entity on a particular statutory holiday. In some cases, both the first and second data sources may provide congruous data regarding the operating status of the first operating entity on the particular statutory holiday; whereas in other cases, both the first and second data source may provide conflicting data regarding the operating status of the first operating entity on the particular statutory holiday.

At block 106, each of the data groups is provided with a data group identifier. Any type of identifier may be used. For example, the identifier may be a sequence of numbers or letters, or both.

Still referring to FIG. 1, at block 108 of method 100, each of the retrieved data subsets within each of the data groups is provided with a retrieved data subset trust score based on intrinsic and extrinsic attributes. As outlined above, a trust score may be based on at least one of an identity of the data source, an origination date of the retrieved data (i.e., the date the data source generated the data and not necessary the date the data was retrieved), the subject matter of the retrieved data, and the consistency of the retrieved data subset with other retrieved data. Other factors may also be used when determining the trust score, such as data freshness, contextual relevance, schema consistency, completeness of information, conflicts with known truths, cross-verification, cadence of change, and accreditation of the data source. For example, some entities may be considered trustworthy based on publicly available historic reputations in the marketplace, and this may be reflected in the trust score. Some entities may be considered trustworthy based on internal historic records of providing accurate data, and this may be reflected in the trust score. The origination date of retrieved data may be considered when assigning a trust score as more recently generated data may be considered more accurate.

As outlined previously, multiple factors may be jointly considered when providing a retrieved data subset with a trust score. For example, when the origination date of the data is recent and the identity of the data source is known as a trustworthy source, that data may be considered relatively accurate and provided with a relatively high trust score.

In addition, the subject matter of the retrieved data subset may be used as an indicator of the accuracy of the data; in particular, when considered in view of the identity of the data source. That is, for example, if a first operating entity provides data regarding their own hours of operation, that retrieved data may be considered trustworthy. Whereas if that first operating entity provides data regarding a third parties' hours of operation, that retrieved data may be considered relatively less trustworthy.

As a second example of how the subject matter of the retrieved data may impact the provided trust score, it has been found that retrieved data such as an entity's address is generally accurate whereas retrieved data such as number of staff scheduled to work on a particular date is generally less accurate.

Regarding how the consistency of the retrieved data subset with other retrieved data may impact the provided trust score, it has been found that the accuracy of a retrieved data subset may be, at least in part, inferred from additional/other retrieved data. For example, a first data source may provide data regarding the employee schedule at a particular operating entity on a particular day. A second data source may provide data regarding the hours of operation of that same operating entity on that same day. If the data regarding the employee schedule indicates that no employees are working that day and the data from the second data source indicates that the hours of operation are from 9 am to 5 pm, it may be determined that one of the two retrieved data subsets is incorrect. Accordingly, in this example, the trust score for the retrieved data subsets relating to hours of operation and scheduling may be relatively low in view of the conflicting data. It will be appreciated that other trust score indicators (e.g., identity of the data source, origination of the retrieved data, subject matter of the retrieved data) may also be taken into account when determining the trust score for the data subset of this example.

It is noted that a retrieved data subset may be provided with a relatively low retrieved data subset trust score even if that retrieved data subset is factually correct because the accuracy of the retrieved data subset is not known and can only be predicted based on factors that are used to generate the retrieved data subset trust score.

After each of the data groups have been provided with a data group identifier at block 106, at block 110, each of the data group identifiers are compared with stored data group identifiers of stored data groups. Stored data groups include historic data (e.g., previously retrieved data subsets) that has been previously retrieved from the same or different data sources. Stored data groups may include previously retrieved data subsets of any age. That is, the previously retrieved data subsets within the stored data groups may contain data that is years, months, weeks, days, hours, minutes, or seconds old. The stored data groups may be stored on at least one memory device (discussed in more detail below).

Each of the previously retrieved data subsets within the stored data groups may be provided with a previously retrieved data subset trust score. The previously retrieved data subset trust score may be based on similar factors to those described above with reference to retrieved data subset trust scores.

The previously retrieved data subset trust score may or may not be updated at a predetermined frequency. As it may be appreciated, the origination date of the previously retrieved data subsets may be more heavily weighted when updating the previously retrieved data subset trust score. In some examples, the previously retrieved data subset trust score of a previously retrieved data subset may be updated yearly, quarterly, monthly, daily, etc. In some examples, the previously retrieved data subset trust score of a previously retrieved data subset may be updated only after the data group identifier of that previously retrieved data subset is matched with the data group identifier of a data group in block 110.

At block 112, if the data group identifier of the data group of a retrieved data subset matches a stored data group identifier of the stored data group then that retrieved data subset and its associated retrieved data subset trust score may be added to the stored data group of the stored data group having the matching stored data group identifier. Put another way, at block 112, the stored data groups are updated to include corresponding retrieved data subsets and their associated retrieved data subset trust scores.

In some examples, providing a retrieved data subset with a retrieved data subset trust score at block 108 includes comparing that retrieved data subset with a stored data subset and the retrieved data subset trust score may be determined at least in part based on consistency/similarity of the retrieved data subset with the previously retrieved data subsets. Optionally, after the retrieved data subset is added to a stored data group at block 112, the retrieved data subset trust score of that retrieved data subset may be updated. Updating the retrieved data subset trust score may be completed automatically or by way of operator review. In some examples, an operator may be prompted to review and approve or deny an update to the retrieved data subset trust score. As an example, if the previously retrieved data subsets all indicate that on Mondays, the operating entity is open from 8 am to 4 pm, and the retrieved data subset also indicated that on Mondays, the operating entity is open from 8 am to 4 pm, then the retrieved data subset trust score of that retrieved data subset may be updated accordingly (in this example the trust score may be increased as there are new indications that the data is accurate).

In some examples, if the data group identifier of a data group of a retrieved data subset does not match a stored data group identifier of the stored data group then a new stored data group may be generated. The new stored data group may include the unmatched retrieved data subset and its associated retrieved data subset trust score.

Still referring to FIG. 1, at block 114 of method 100, a data subset prediction to generate is identified. The data subset prediction to generate may be identified manually by an operator of the system or automatically (e.g., certain data subset predictions may be generated on a repeating schedule, certain data subset predictions may be scheduled to generate following a event (e.g., upon notification of a healthcare provider closing down), certain data subset predictions may be scheduled to generate as part of a larger planning project or based on historical trends, etc.). For example, at block 114, the data subset prediction to generate may be identified as the operating status of a healthcare operating entity (e.g., the hours of operation of an operating entity for the following Friday). As a second example, the data subset prediction to generate may be identified as demand for a healthcare service within a geographical region on a particular date. As a third example, the data subset prediction to generate may be identified as a repercussion indication (described in more detail below).

After the data subset to predict is identified at block 114, at block 116, at least one of the stored data groups is identified as being required to generate the data subset prediction. To identify the stored data group required to generate the data subset prediction, in one example, the identified at least one data subset prediction to generate is provided with a data subset prediction identifier and identifying the at least one of the stored data subsets required to generate the at least one data subset prediction includes matching the data subset prediction identifier with a stored data subset identifier of the stored data subsets.

In another example, to identify the stored data group required to generate the data subset prediction includes (a) identifying at least one data type subset within the identified at least one data subset prediction required to generate the at least one data subset prediction; (b) providing each of the at least one data type subsets with a data type subset identifier; and (c) matching the each of the at least one data type subset identifiers with a stored data subset identifier of the stored data subsets. That is, in some examples, multiple stored data groups may be required to generate the identified data subset prediction. For example, the identified data subset prediction may be a shortage of flu vaccines in a particular region on a particular date. To generate this prediction, data such as number of available flu vaccines at operating entities within the particular region, data such as projected number of individuals seeking flu vaccines, data such as which operating entities are within the particular region, and data such as number of doctors and nurses working on the particular date, etc. may all be required to generate the prediction.

In some examples, one or more of machine learning and artificial generative intelligence (AGI) may be used identify the stored data group(s) required to generate the data subset prediction. For example, methods such as feature selection, recursive feature elimination, correlation matrices, and meta-learning may be used to isolate the most predictive variables, while clustering (e.g., k-means, DBSCAN), dimensionality reduction (e.g., PCA, t-SNE), and autoencoders or embedding models may be used to group similar data attributes, organizations and behavior patterns. Data quality and accuracy may be improved using anomaly detection (e.g., Isolation Forest, Prophet), trust-weighted filtering, temporal pattern mining, lag-aware segmentation, and process analysis to exclude outdated, inconsistent, or low-confidence inputs and to establish trust scores with forecasting focused timely, high-quality, and context-specific signals.

After block 114 and block 116, at block 118, the data subset prediction is generated. The data subset prediction is generated based on the added retrieved data subset and the associated retrieved data subset trust score of the stored data group required to generate the data subset prediction and the previously retrieved data subsets and the associated previously retrieved data subset trust scores of the stored data group required to generate the data subset prediction. In some examples, the generated data subset prediction may be the retrieved data subset or the previously retrieved data subset having the highest associated trust score. In other examples, the generated data subset prediction may be an extrapolation from at least one of the retrieved data subset or the previously retrieved data subset having the highest associated trust score(s).

After the data subset prediction is generated, a healthcare related service may be modified in view of the data subset prediction at step 120. That is, for example, data subset predictions can be used to predict patient volume surges at urban clinics during holidays, which may (a) lead to extending operating hours at at least one of the urban clinics; (b) enable proactive patient awareness of same-day/next-day service availability; (c) lead to staff reallocation. As a second example, data subset predictions can be used to predict demand for inhalers and antibiotics which may lead to inventory resupply prioritization at pharmacies near respiratory illness hotspots. As a third example, data subset predictions can be used to predict small clinics at high risk of staff absenteeism due to weather and burnout which may lead to coordination of service deliveries with other nearby clinics and/or pre-schedule backup staff and remote work options. As a fourth example, data subset predictions can be used to predict regions with low screening rates but high appointment availability, which may lead to targeted patient outreach campaigns. As a fifth example, data subset predictions can be used to predict clinics with unpredictable no-show rates, which may lead to putting overbooking strategies into practice.

In these and other examples, generating the data subset prediction may include the use of artificial intelligence and/or data analytics based on, at least in part, one or more of the retrieved data subset trust score, the previously retrieved data subset trust score, historical data, contextual data, and data type.

Optionally, in some examples, the data subset prediction may include a likeliness score. For example, the data subset prediction may indicate that there is a 0%, 10%, 20%, 30%, 40%, 50%, 60%, 70%, 80%, 90%, or 100% (or any number therebetween) chance of the data subset prediction being correct. The likeliness score may be calculated by combining the model's predictive confidence with the trust score of the input data, calibrated using techniques like Platt Scaling, and adjusted based on historical accuracy for similar predictions, ensemble model agreement, and quantified uncertainty from Bayesian methods. This method may ensure that each prediction reflects not only the model's output, but also the reliability of the data, consistency across models, and real-world validation.

Optionally, after block 118, the previously retrieved data subset trust scores may be updated based on a correctness of the generated data subset prediction. That is, if the generated data subset prediction is later verified to be correct, the trust score of the added retrieved data subset and/or trust score of the previously retrieved data subsets may be updated to reflect whether the prediction was correct or not. To verify if the generated data subset prediction is correct, both current and historical information may be reviewed. This review may be completed via system integration with content management systems (CMS), electronic medical record software (EMR), electronic health records (EHR), customer relationship management (CRM), enterprise resource planning software (ERP) and inventory management software, scheduling calendars, internal & external facing databases, and repositories. In some examples, review may be completed through physical measurement and surveying of patients and systems. In some examples, review may also be completed, at least in part, by way of phone, fax, email, surveys, census, and/or public postings.

In some examples, method 100 may include (a) identifying a second data subset prediction to generate; (b) identifying at least one of the stored data groups required to generate the second data subset prediction; and (c) generating the second data subset prediction based on the added retrieved data subset and the associated retrieved data subset trust score of the stored data group required to generate the second data subset prediction and the previously retrieved data subsets and the associated previously retrieved data subset trust scores of the stored data group required to generate the second data subset prediction. That is, in some examples, multiple data subsets predictions may be generated before additional data is retrieved from the plurality of data sources.

Optionally, the method 100 shown in FIG. 1 may be used to generate a repercussion indication. A repercussion indication is a prediction of how a situation/matter/event may change if an alternative set of facts to reality were true. Use of the method 100 to generate a repercussion indication may be initiated manually by an operator of the system or automatically (e.g., on a repeating schedule, scheduled to initiate following an event, scheduled to initiate as part of a larger planning project or based on historical trends, etc.). As an example, a repercussion indication may be an indication of client demands on current healthcare providers in a particular region if a new pharmacy were to be opened in an adjacent region. As a second example, a repercussion indication may be how client wait times at a particular hospital may be reduced if an additional doctor and/or nurse is scheduled to work on a particular day. As a third example, a repercussion indication may be an indication on healthcare supply demands for a particular day if the hours of operation of a particular operating entity are extended.

When method 100 is used to generate a repercussion indication, retrieving data from a plurality of data sources at block 102 may include retrieving data (fictional data) from at least one forecasting entity. The data received from the forecasting entity may be related to a particular repercussion indication (i.e., data subset prediction to generate) of interest. In this example, the data retrieved from the forecasting entity may include at least one retrieved data subset, wherein at least one of the at least one retrieved data subsets is a first retrieved data subset belonging to a data group having a first data group identifier and identifying the at least one of the stored data subsets required to generate the at least one data subset prediction comprises matching the data subset prediction identifier with a stored data subset identifier of the stored data subsets having the first data group identifier.

Optionally, the method 100 may include a step of removing each of the at least one retrieved data subsets retrieved from the forecasting entity from the stored data subset of the stored data subsets after generating the data subset prediction. It may be desirable to remove the retrieved data subset from the forecasting entity from the stored data to ensure future data subset predictions are not influenced based on this data (fictional data). That being said, in some examples, it may be desirable to keep the retrieved data subset from the forecasting entity within the stored data subset if there are multiple data subset predictions to generate based on the data from the forecasting entity (i.e., a multi-tiered repercussion indication). That is, for example, the data subset prediction to generate may be an indication on client demands on current healthcare providers on a particular date in a particular region if a new pharmacy were to be opened in an adjacent region and one of the current healthcare providers in the particular region is closed on the particular date.

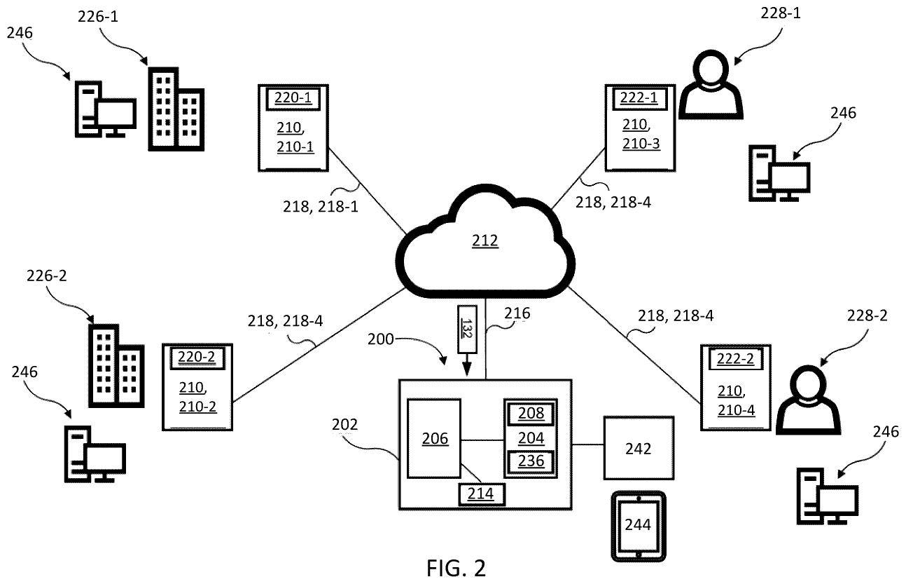

Referring now to FIG. 2, shown therein is an exemplary system 200 for generating a data subset prediction according to method 100 as described above, in accordance with non-limiting embodiments. It is to be understood, that method 100 can be implemented on variations of system 200. That is, system 200 can be varied, and need not work exactly as discussed herein, and that such variations are within the scope of present implementations.

As shown in FIG. 2, system 200 may include a data handling engine 202. The data handling engine 102 includes at least one memory 204 and at least one processing device 206. Memory 204 can comprise any suitable memory device, including but not limited to any suitable one of, or combination of, a local and/or remote volatile memory, non-volatile memory, random access memory (RAM), read-only memory (ROM), hard drive, optical drive, buffer(s), cache(s), flash memory, magnetic computer storage devices (e.g. hard disks, floppy disks, and magnetic tape), optical memory ((e.g., CD(s) and DVD(s)), and the like. Other suitable memory devices are within the scope of the application. As such, it is understood that the term “memory”, or any variation thereof, as used herein may comprise a tangible and non-transitory computer-readable medium (i.e., a medium which does not comprise only a transitory propagating signal per se) comprising or storing computer-executable instructions, such as computer programs, sets of instructions, code, software, and/or data for execution of any method(s), step(s) or process(es) described herein by any processing device(s) and/or microcontroller(s) described herein. Memory 204 comprises or is enabled to store computer-executable instructions 208 for execution by at least one processing device, including processing device 206. Memory 204 comprises or is further enabled to store stored data groups 236.

Processing device 206 is coupled to memory 204 and is enabled to control at least some of the operations system 200. As used herein, the terms “processing device”, “processing devices”, “processing device(s)”, “processor”, “processors” or “processor(s)” may refer to any combination of processing devices, and the like, suitable for carrying out the actions or methods described herein. For example, processing device 206 may comprise any suitable processing device, or combination of processing devices, including but not limited to one or multiple microprocessors, central processing units (CPUs), graphics processing units (GPUs), and the like. Other suitable processing devices are within the scope of the application.

Although system 200 is depicted as a single computing system, it is to be understood that according to some aspects of the application system 200 may comprise multiple computing systems and/or computing devices in which one or more of the computing systems and/or computing devices may be remote from each other (e.g., one or more servers, mobile devices and other suitable computing devices). Although memory 204 and processor 206 are shown as being co-located on the same computing device, it is understood that according to some embodiments memory 204 and processor 206 may be remote from each other.

Still referring to FIG. 2, in the example illustrated, system 200 is enabled to communicate with a plurality of data sources, such as data sources 210 (individually data source 210-1, data source 210-2, data source 210-3 and data source 210-4) via, for example, network 212 (which, according to some embodiments, is a secure network) to retrieve, for example, unstructured data 220-1, 220-2 and/or structured data 222-1, 222-2. For example, according to some embodiments, system 200 comprises communication module 214 coupled to processor 206. Communication module 214 may be enabled to access data sources 210 over network 212 and via, for example, communication links 216 and 218 (individually communication link 218-1, communication link 218-2, communication link 218-3, and communication link 218-4). Communication module 214 comprises any communication device(s) and/or application(s), or combination thereof, suitable for performing the communications with data sources 210 described herein. Communication links 216 and 218 comprise any suitable wired and/or wireless communication link(s), or suitable combination thereof. Communication module 214 is also enabled to communicate according to any suitable protocol which is compatible with network 212. Non-limiting examples of suitable protocols which may be compatible with network 212 are wireless protocols, cell-phone protocols, wireless data protocols, WiFi protocols, WiMax protocols, and/or a combination, or the like, such as Wired Equivalent Privacy (WEP), Wi-Fi Protected Access (WPA), Secure Sockets Layer (SSL) and Transport Layer Security (TLS). Communication module 214 may be enabled to process data for transmission between system 200 and data sources 210 in accordance to security protocols associated with network 212. For example, according to some embodiments, communication module 214 is enabled to decrypt data retrieved from any one of data sources 210 via network 212. According to some embodiments, processing device 206 is enabled similarly to communication module 214 such that processing device 206 performs at least some of the communications with computing device 110 described herein rather than communication module 214.

As described above, according to some embodiments, one or more of the data sources 210 may be associated with an entity or individual that maintains the respective one of data sources 210, such as entities 226-1, 226-2 and individuals 228-1, 228-2.

Computer-executable instructions 208, when executed by processor 206, is enabled to cause processor 206 to perform at least some portions of the method 100, as described above.

It is appreciated that, in some aspects, method 200 is implemented by system 100 by processing device 206. Indeed, method 100 is one way in which system 200 may be configured.

According to some embodiments, at least some of retrieved data is encrypted in transit and encrypted at rest to ensure secure handling of sensitive information, and to reduce data leakage.

According to some embodiments, system 200 further comprises application programming interface (API) 242 through which the functionalities and/or outputs of data handling engine 202 can be accessed. For example, according to some embodiments, API 242 is configured to provide a navigation service which may communicate with internal and external applications such as, without limitation, patient/client portals, digital front door, wayfinding websites, wayfinding applications, eReferral programs, eConsult programs, ride-sharing platforms, public transit services, clinical services providers, service providers at various governmental levels (such as at the municipal, regional and national-level) and service providers at the institutional level (e.g., retail chains, banners, professional groups). According to some embodiments, API 242 provides backend access for authorized users to data handling engine 202. For example, according to some embodiments, API 242 provides access to AI prompts and/or models to enable modification of same.

API 242 may be accessed by a user through one or more computing devices, such as computing device 244. Computing device 244 comprises any suitable computing device, including but not limited to one or more portable electronic devices, mobile computing devices, portable computing devices, tablet computing devices, laptop computing devices, PDAs (personal digital assistants), cellphones, smartphones, computer terminals and the like. Other suitable computing devices are within the scope of the application. For the sake of simplicity, a single computing device 244 is shown in FIG. 2. However, according to some aspects, more than one computing device 244 is enabled to access API 242.

According to some embodiments, other functionalities of data handling engine 202, such as the outputs, may be accessed via computing devices 246 accessible by individuals 228 and/or entities 226. Computing devices 246 comprise any suitable computing devices, including but not limited to one or more portable electronic devices, mobile computing devices, portable computing devices, tablet computing devices, laptop computing devices, PDAs (personal digital assistants), cellphones, smartphones, computer terminals and the like. Other suitable computing devices are within the scope of the application.

Those skilled in the art will appreciate that in some implementations, the functionality of system 200 and method 100 can be implemented using pre-programmed hardware or firmware elements (e.g., application specific integrated circuits (ASICs), electrically erasable programmable read-only memories (EEPROMs), etc.), or other related components. In other implementations, the functionality of system 200 and method 100 can be achieved using a computing apparatus that has access to a code memory (not shown) which stores computer-readable program code for operation of the computing apparatus. The computer-readable program code could be stored on a computer readable storage medium which is fixed, tangible and readable directly by these components, (e.g., removable diskette, CD-ROM, ROM, fixed disk, USB drive). Furthermore, it is appreciated that the computer-readable program can be stored as a computer program product comprising a computer usable medium. Further, a persistent storage device can comprise the computer readable program code. It is yet further appreciated that the computer-readable program code and/or computer usable medium can comprise a non-transitory computer-readable program code and/or non-transitory computer usable medium. Alternatively, the computer-readable program code could be stored remotely but transmittable to these components via a modem or other interface device connected to a network (including, without limitation, the Internet) over a transmission medium. The transmission medium can be either a non-mobile medium (e.g., optical and/or digital and/or analog communications lines) or a mobile medium (e.g., microwave, infrared, free-space optical or other transmission schemes) or a combination thereof.

Persons skilled in the art will appreciate that there are yet more alternative aspects and modifications possible, and that the above examples are only illustrations of one or more aspects of the application. The scope, therefore, is only to be limited by the claims appended hereto.

### INTERPRETATION

It will also be understood that for the purposes of this application, “at least one of X, Y, and Z” or “one or more of X, Y, and Z” language can be construed as X only, Y only, Z only, or any combination of two or more items X, Y, and Z (e.g., XYZ, XYY, YZ, ZZ).

In the present application, components may be described as “configured to” or “enabled to” perform one or more functions. Generally, it is understood that a component that is configured to or enabled to perform a function is configured to or enabled to perform the function, or is suitable for performing the function, or is adapted to perform the function, or is operable to perform the function, or is otherwise capable of performing the function.

Additionally, components in the present application may be described as “operatively connected to”, “operatively coupled to”, and the like, to other components. It is understood that such components are connected or coupled to each other in a manner to perform a certain function. It is also understood that “connections”, “coupling” and the like, as recited in the present application include direct and indirect connections between components.

References in the application to “one embodiment”, “an embodiment”, “an implementation”, “a variant”, etc., indicate that the embodiment, implementation or variant described may include a particular aspect, feature, structure, or characteristic, but not every embodiment, implementation or variant necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely”, “only”, and the like, in connection with the recitation of claim elements or use of a “negative” limitation. The terms “preferably”, “preferred”, “prefer”, “optionally”, “may”, and similar terms are used to indicate that an item, condition or step being referred to is an optional (not required) feature of the invention.

The singular forms “a”, “an”, and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

What is claimed is:

1. A method for generating a data subset prediction and providing a healthcare related service based on said data subset prediction comprising:
retrieving data from a plurality of data sources, wherein one or more of the plurality of data sources comprises at least one of structured and unstructured data;
sorting the retrieved data into data groups of retrieved data subsets;
for each of the data groups, providing the data group with a data group identifier;
providing each of the retrieved data subsets within each of the data groups with a retrieved data subset trust score, wherein the retrieved data subset trust score is based on at least one of:
an identity of the data source;
an origination date of the retrieved data;
subject matter of the retrieved data; and
consistency of the retrieved data subset with other retrieved data;
for each of the data groups, comparing the data group identifier with stored data group identifiers of stored data groups which are stored on at least one memory device, wherein the stored data groups each comprise at least one previously retrieved data subset, wherein each of the at least one previously retrieved data subsets has a previously retrieved data subset trust score; and
for each of the retrieved data subsets of each of the data groups, adding the retrieved data subset and its associated retrieved data subset trust score to one of the stored data groups of the stored data groups if the data group identifier of the data group of the retrieved data subset matches a stored data group identifier of the stored data group, the retrieved data subset and its associated retrieved data subset trust score being added to the stored data group having the stored data group identifier that matches the data group identifier of the data group of the retrieved data subset; and
identifying a data subset prediction to generate;
identifying at least one of the stored data groups required to generate the data subset prediction;
generating the data subset prediction based on the added retrieved data subset and its associated retrieved data subset trust score of the stored data group required to generate the data subset prediction and the previously retrieved data subsets and its associated previously retrieved data subset trust scores of the stored data group required to generate the data subset prediction; and
modifying a healthcare service based on the data subset prediction.

2. The method of claim 1,
further comprising
providing the identified data subset prediction to generate with a data subset prediction identifier; and
wherein
identifying the at least one of the stored data subsets required to generate the data subset prediction comprises matching the data subset prediction identifier with a stored data subset identifier of the stored data subsets.

3. The method of claim 1, wherein
identifying the at least one of the stored data subsets required to generate the at least one data subset prediction comprises:
identifying at least one data type subset within the identified data subset prediction to generate required to generate the data subset prediction;
providing each of the at least one data type subsets with a data type subset identifier; and
matching each of the at least one data type subset identifiers with a stored data subset identifier of the stored data subsets.

4. The method of claim 1, wherein
retrieving data from a plurality of data sources comprises retrieving data from at least one forecasting entity, the data retrieved from the forecasting entity including at least one retrieved data subset, wherein at least one of the at least one retrieved data subset is a first retrieved data subset belonging to a data group having a first data group identifier; and
identifying the at least one of the stored groups required to generate the at least one data subset prediction comprises matching the data subset prediction identifier with a stored data subset identifier of the stored data subsets having the first data group identifier.

5. The method of claim 4, further comprising
removing each of the at least one retrieved data subset retrieved from the forecasting entity from the stored data subset of the stored data subsets after generating the data subset prediction.

6. The method of claim 1, further comprising:
updating the retrieved data subset trust score after adding the retrieved data subset of that retrieved data subset trust score to the one of the stored data groups of the stored data groups based on consistency of the retrieved data subset with the previously retrieved data subsets in that stored data group of the stored data groups.

7. The method of claim 1, further comprising:
updating the previously retrieved data subset trust scores after generating the data subset prediction based on a correctness of the generated data subset prediction.

8. The method of claim 1, wherein
retrieving data from a plurality of data sources comprises retrieving data from at least one operating entity.

9. The method of claim 1, wherein the data subset prediction comprises a likeliness score.

10. The method of claim 1, further comprising, for each retrieved data subset of each of the data groups,
generating a new stored data group with the stored data groups which are stored on the at least one memory device, the new stored data group including that retrieved data subset and its associated retrieved data subset trust score, if the data group identifier of the data group of that retrieved data subset does not match a stored data group identifier of the stored data groups.

11. The method of claim 1, wherein generating the data subset prediction comprises use of artificial intelligence and/or data analytics based on, at least in part, one or more of the retrieved data subset trust score, the previously retrieved data subset trust score, and historical data.

12. The method of claim 1, wherein providing each of the retrieved data subsets within each of the data groups with the retrieved data subset trust score comprises:
comparing that retrieved data subset with a stored data subset, wherein the data group identifier of the data group of that retrieved data subset matches the stored data group identifier of the stored data group of the stored data subset being compared to; and
determining the retrieved data subset trust score based at least in part on the similarity between that retrieved data subset and the stored data subset.

13. The method of claim 1, wherein the data subset prediction is demand for a healthcare service within a geographical region.

14. The method of claim 1, wherein the data subset prediction is an operating status of a healthcare operating entity.

15. The method of claim 1, wherein the data subset prediction is a repercussion indication.

16. The method of claim 1, further comprising:
identifying a second data subset prediction to generate;
identifying at least one of the stored data groups required to generate the second data subset prediction; and
generating the second data subset prediction based on the added retrieved data subset and its associated retrieved data subset trust score of the stored data group required to generate the second data subset prediction and the previously retrieved data subsets and its associated previously retrieved data subset trust scores of the stored data group required to generate the second data subset prediction.

17. A system for generating a data subset prediction comprising:
a data handling engine in communication with a plurality of data sources comprising:
at least one memory device configured to store computer-executable instructions and the data subset prediction; and
a processing device coupled to the memory device;
wherein the computer executable instructions when executed by the processing device causes the processing device to:
retrieve data from a plurality of data sources, wherein one or more of the plurality of data sources comprises at least one of structured and unstructured data;
sort the retrieved data into data groups of retrieved data subsets;
for each of the data groups, provide the data group with a data group identifier;
provide each of the retrieved data subsets within each of the data groups with a retrieved data subset trust score, wherein the retrieved data subset trust score is based on at least one of:
an identity of the data source;
an origination date of the retrieved data;
subject matter of the retrieved data; and
consistency of the retrieved data subset with other retrieved data;
for each of the data groups, compare the data group identifier with stored data group identifiers of stored data groups which are stored on at least one memory device, wherein the stored data groups each comprise at least one previously retrieved data subset, wherein each of the at least one previously retrieved data subsets has a previously retrieved data subset trust score;
for each of the retrieved data subsets of each of the data groups, add the retrieved data subset and its associated retrieved data subset trust score to one of the stored data groups of the stored data groups if the data group identifier of the data group of the retrieved data subset matches a stored data group identifier of the stored data group, the retrieved data subset and its associated retrieved data subset trust score being added to the stored data group having the stored data group identifier that matches the data group identifier of the data group of the retrieved data subset;
identify a data subset prediction to generate;
identify at least one of the stored data groups required to generate the data subset prediction; and
generate the data subset prediction based on the added retrieved data subset and its associated retrieved data subset trust score of the stored data group required to generate the data subset prediction and the previously retrieved data subsets and its associated previously retrieved data subset trust scores of the stored data group required to generate the data subset prediction.

18. The system of claim 17, wherein the retrieved data is encrypted and the computer-executable instructions when executed by the processing device further causes the processing device to decrypt the retrieved data.

19. The system of claim 17, further comprising an application interface for the data handling engine.

20. A non-transitory computer readable medium for generating a data subset prediction, comprising computer-executable instructions for:
retrieving data from a plurality of data sources, wherein one or more of the plurality of data sources comprises at least one of structured and unstructured data;
sorting the retrieved data into data groups of retrieved data subsets;
for each of the data groups, providing the data group with a data group identifier;
providing each of the retrieved data subsets within each of the data groups with a retrieved data subset trust score, wherein the retrieved data subset trust score is based on at least one of:
an identity of the data source;
an origination date of the retrieved data;
subject matter of the retrieved data; and
consistency of the retrieved data subset with other retrieved data;
for each of the data groups, comparing the data group identifier with stored data group identifiers of stored data groups which are stored on at least one memory device, wherein the stored data groups each comprise at least one previously retrieved data subset, wherein each of the at least one previously retrieved data subsets has a previously retrieved data subset trust score;
for each of the retrieved data subsets of each of the data groups, adding the retrieved data subset and its associated retrieved data subset trust score to one of the stored data groups of the stored data groups if the data group identifier of the data group of the retrieved data subset matches a stored data group identifier of the stored data group, the retrieved data subset and its associated retrieved data subset trust score being added to the stored data group having the stored data group identifier that matches the data group identifier of the data group of the retrieved data subset;
identifying a data subset prediction to generate;
identifying at least one of the stored data groups required to generate the data subset prediction; and
generating the data subset prediction based on the added retrieved data subset and its associated retrieved data subset trust score of the stored data group required to generate the data subset prediction and the previously retrieved data subsets and its associated previously retrieved data subset trust scores of the stored data group required to generate the data subset prediction.
